(19) United States
(12) Patent Application Publication
(10) Pub. No.: US 2007/0161347 A1
(43) Pub. Date: Jul. 12, 2007

(54) Enabling a digital wireless service for a mobile station across two different wireless communications environments

(75) Inventors: Zhengxiang Ma, Summit, NJ (US); Arnold B. Siegel, Somerset, NJ (US); Theodore Sizer II, Little Silver, NJ (US); Stephen A. Wilkus, Lincroft, NJ (US)

Correspondence Address: WILLIAMS, MORGAN & AMERSON, 10333 RICHMOND, SUITE 1100, HOUSTON, TX, 77042, US

(73) Assignee: Lucent Technologies, Inc.

(21) Appl. No.: 11/329,370

(22) Filed: Jan. 10, 2006

(51) Int. Cl. H04B 7/15

(52) U.S. Cl. 455/11.1; 455/522; 455/69

(57) ABSTRACT

A method and an apparatus for enabling a digital wireless service across a first and a second wireless communications environment is provided. The method comprises translating a receive signal carried on a forward link and having a first carrier frequency in the first wireless communications environment from a first frequency band to a second frequency band different from the first frequency band. The method further comprises translating a transmit signal carried on a reverse link and having a second carrier frequency in the first wireless communications environment from the second frequency band to the first frequency band. In this way, a digital wireless service may be provided between a mobile station and at least one base station on the ground across two different wireless communications environments. The method further comprises compensating Doppler shift separately for individual beams directed at a plurality of terrestrial base stations. The method further comprises injecting an additional path delay to insure that the terrestrial base stations receive reverse link signals at substantially similar round trip time offsets and to reduce search windows for the terrestrial base stations. In this way, a wireless communication system may enable in-flight use of a mobile station to communicate with one or more base stations on the ground.

### BACKGROUND OF THE INVENTION

1. Field of the Invention

This invention relates generally to telecommunications, and more particularly, to wireless communications.

2. Description of the Related Art

As per regulations of Federal Communications Commission (FCC), a government agency responsible for regulating telecommunications in the United States of America (USA), airlines require passengers on board a commercial airline to turn off user electronic equipment before take off. In particular, while the FCC restricts use of cellular equipment in aircraft (880 MHz band, not the 1800 MHz), the Federal Aviation Administration (FAA) restricts the use of electronics in general. Thus, both the FAA and FCC regulations expressly forbid use of such devices, including cell phones, while airborne to avoid interference with a terrestrial system that provides wireless communications across a large area on the ground. However, once the airplane reaches cruising altitude, the passengers can resume use of certain electronic equipment, excluding any wireless communication devices, such as cell phones.

One of the reasons for forbidding the use of cell phones is interference on the ground from a cellular wireless communication of a cell phone that is airborne. For example, a radio frequency (RF) signal from a cell phone within an airplane at high altitude may cause undesired interference to receivers of the terrestrial cellular system since propagation of the RF signal produces high levels of interference to a large area on the ground covered with many terrestrial Base Station Transceiver stations (BTS). This type of interference may significantly impact overall system capacity of one or more wireless communication systems on the ground.

For example, in a Code Division Multiple Access (CDMA) or a wideband CDMA (WCDMA) system with a frequency reuse factor of 1, since all the terrestrial BTS radiate at the same frequency, a cell phone may experience severe pilot pollution problem. That is, as a result of favorable propagation condition(s), signals from multiple BTSs may arrive at the user with comparable strength and interfere with each other.

A relatively high Doppler shift results due to high traveling speed, as a typical cruising speed of a commercial airline is about 500 m/h (800 km/h), causing a Doppler shift of the carrier frequency received at the BTS in excess of a desired level, such as above 4 KHz, which is well beyond many standard specifications for digital wireless communications systems. Under such circumstances, a significant performance and overall system capacity degradation may occur.

Despite potential interference with navigation flight-critical systems, most air travelers still would like to communicate while on board an airplane if it is affordable. Different commercial phone services are available on a large number of commercial airline flights. Most of such commercial phone services use proprietary air-interface with low capacity. However, usage charges for such wireless services is very high, for example, in the range of a few dollars per minute, therefore, most travelers usually choose not to take advantage of the wireless services. For example, several domestic airline flights in USA are equipped with an Airfone service, which uses 135 ground stations and three switching stations to support the links at 849-851 MHz air-to-ground and 894-896 MHz for ground to air.

Another wireless service provider on board an airplane uses protocol translating repeaters to enable the use of cell phones in an analog mode on board the airplane. However, the analog equipment does not support digital standards that offer more comprehensive and data intensive services such as high-speed data access. Alternatively, installing a pico BTS or Node B on board the airplane and backhauling it through either an air-to-ground or a satellite link at a different frequency may be expensive. Backhauling through satellite may be cost prohibitive due to the high costs of launching satellites. An additional penalty of long delay may cause a low voice quality if the satellite is geosynchronous. For the air-to-ground backhaul link, many existing standard air-interfaces, e.g., CDMA/WCDMA do not allow use of a pico-cell BTS on board aircraft with two back-to-back CDMA/WCDMA air-interfaces at two different frequencies.

### SUMMARY OF THE INVENTION

The following presents a simplified summary of the invention in order to provide a basic understanding of some aspects of the invention. This summary is not an exhaustive overview of the invention. It is not intended to identify key or critical elements of the invention or to delineate the scope of the invention. Its sole purpose is to present some concepts in a simplified form as a prelude to the more detailed description that is discussed later.

The present invention is directed to overcoming, or at least reducing, the effects of one or more of the problems set forth above.

In one embodiment of the present invention, a method is provided for enabling a digital wireless service across a first and a second wireless communications environment. The method comprises translating a receive signal carried on a forward link and having a first carrier frequency in the first wireless communications environment from a first frequency band to a second frequency band different from the first frequency band. The method further comprises translating a transmit signal carried on a reverse link and having a second carrier frequency in the first wireless communications environment from the second frequency band to the first frequency band.

In another embodiment of the present invention, a method is provided for enabling a digital wireless service on board an aircraft for a mobile station and at least one base station on the ground. The method comprises translating, on board the aircraft, a frequency of a receive signal over a first carrier frequency on a forward link to a cellular frequency band from a non-cellular frequency band. The method further comprises translating, on board the aircraft, a frequency of a transmit signal over a second carrier frequency on a reverse link from the cellular frequency band to the non-cellular frequency band.

### BRIEF DESCRIPTION OF THE DRAWINGS

The invention may be understood by reference to the following description taken in conjunction with the accompanying drawings, in which like reference numerals identify like elements, and in which:

FIG. 1 schematically depicts a wireless communication system which includes first and second repeaters to enable in-flight communication associated with a digital wireless service on board an aircraft for a mobile device and at least one of a plurality of base stations distributed over a large geographical area on the ground in accordance with one embodiment of the present invention;

FIG. 2 schematically depicts a stylized representation for implementing a method using a different frequency for providing in-flight wireless communications between an air-to-ground band and a cellular band according to one embodiment of the present invention;

FIG. 3 depicts a stylized representation for representing a method of translating frequency from one band to another band for transmit and receive signals on reverse and forward links between an airborne aircraft and the plurality of base stations at the ground according to one embodiment of the present invention;

FIG. 4 schematically depicts a stylized representation for implementing a method of receiving a signal from a base station for the mobile station at a first repeater on board the aircraft in accordance to one embodiment of the present invention; and

FIG. 5 schematically depicts the first repeater shown in FIG. 1 according to one embodiment of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions may be made to achieve the developers' specific goals, such as compliance with system-related and business-related constraints, which will vary from one implementation to another. Moreover, it should be appreciated that such a development effort might be complex and time-consuming, but may nevertheless be a routine undertaking for those of ordinary skill in the art having the benefit of this disclosure.

Generally, a method and an apparatus are provided for enabling a digital wireless service between a mobile station and a plurality of base stations located in two different wireless communications environments. For example, the mobile station may be on board a rapidly moving indoor wireless communications environment, such as a high speed train or an aircraft and at least one base station of the plurality of base stations may be located in a stationary outdoor wireless communications environment, such as on the ground. To enable the digital wireless service for the mobile station, a wireless communication system may compensate for a frequency offset in a digital wireless communications transmission between the two different wireless communications environments and provide an indoor retransmission of the digital wireless communications transmission across the two different wireless communications environments. The wireless communication system may enable a digital wireless service on board an aircraft for a mobile station and at least one base station on the ground. The method comprises translating, on board the aircraft, a frequency of a receive signal over a first carrier frequency on a forward link to a cellular frequency band from a first frequency band different than the cellular frequency band. The method further comprises translating, on board the aircraft, a frequency of a transmit signal over a second carrier frequency on a reverse link from the cellular frequency band to the first frequency band. In this way, a wireless communication system may enable in-flight use of a mobile station to communicate with one or more base stations on the ground. A first repeater on board an aircraft may translate the frequency of a transmit signal over a second carrier frequency on a reverse link from a cellular frequency band to a non-cellular frequency band. By using the first repeater, an aircraft transceiver may enable use of the mobile device while the aircraft is airborne. A base station may comprise a second repeater to translate the frequency of a transmit signal on a non-cellular frequency band to cellular frequency band and translate a receive signal on the cellular frequency band for transmission on a forward link to the first repeater. By translating frequencies of the two different frequency bands on board an aircraft and at a base station on the ground, the mobile station may communicate with the base station during flight. A terrestrially based cellular system may enable wireless Internet Protocol (IP) services on board an aircraft with a CDMA-2000 EV-DO air-interface over the 800 MHz air-to-ground (ATG) band. A user of a laptop computer or a wireless handset on board aircraft may access a wireless data/voice service through an access point or a pico-basestation. For example, the access point or pico-basestation may use an IP connection to an Aeronautical Electronic Unit (AEU) that communicates with ground-stations distributed over a large geographical area to backhaul the user IP traffic associated with an in-flight wideband data service. A frequency translating repeater system on board an aircraft and ground stations may enable a digital cellular wireless service during flights. With such a system, a traveler on-board an airplane may use end user equipment, such as a cell phone or a wireless data card to access voice and data service just as possible while still on the ground.

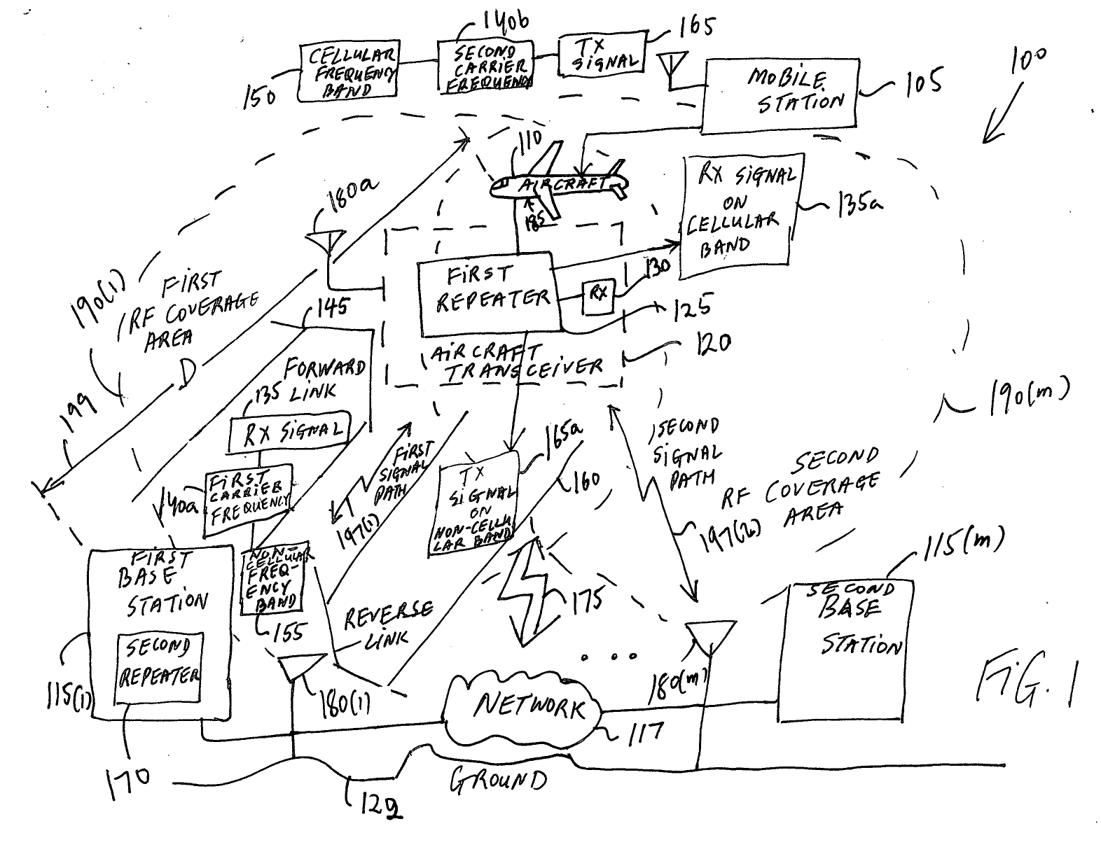

Referring to FIG. 1, a wireless communication system 100 is schematically illustrated for enabling a digital wireless service between a mobile station 105 and a plurality of base stations 115(1-m) located in two different wireless communications environments according to one embodiment of the present invention. For example, the mobile station 105 may be on board a rapidly moving indoor wireless communications environment, such as a high speed train or an aircraft 110 and at least one base station of the plurality of base stations 115(1-m) may be located in a stationary outdoor wireless communications environment, such as on the ground 122 according to one embodiment of the present invention. To enable the digital wireless service for the mobile station 105, the wireless communication system 100 may compensate for a frequency offset in a digital wireless communications transmission between the two different wireless communications environments and provide an indoor retransmission of the digital wireless communications transmission.

In one embodiment of the present invention, the digital wireless service may be based on digital wireless communications transmission that allows a large number of users to access a single radio frequency channel without interference using a Code Division Multiple Access (CDMA)-2000 Evolution-Data only or Evolution-Data Optimized (EV-DO) air-interface over an air-to-ground (ATG) frequency band. For transmission of a digital wireless communication, a cell phone may use frequencies including 1900 MHz or 800 MHz. Examples of the digital wireless service include a digital cellular wireless service including voice and data services as may be accessible on the ground 122.

For providing the digital wireless service, the wireless communication system 100 may be partitioned into connected service domains known as cells, where a radio device, such as the mobile station 105 users communicate via radio frequency links over a wireless medium with a base station 115 (e.g., Node B). The wireless medium may be capable of handling cellular signals with cellular modems. For example, the wireless medium may operate according to Code Division Multiple Access (CDMA) standard or Global System for Mobile Communications (GSM) standard, which is a land mobile pan-European digital cellular radio communications system.

Examples of the base station 115 include Evolution-Data Only or Evolution-Data Optimized (EV-DO) standard compliant and/or 3G standard, such as 3G1X compliant ground stations having a sectorized antenna. In one embodiment, the plurality of base stations 115 may form a hexagonal grid on the ground 122 for the aircraft 110 to communicate a RF signal on a wireless link, such as a forward link 145 from the first base station 115(1) to the mobile station 105 that may be based on the EV-DO standard. The EV-DO standard or the Evolution-Data and Voice (1×EV-DV) standard is based on a wireless radio broadband data protocol adopted by many CDMA mobile phone service providers, as part of the CDMA2000 standard. For example, the 1×EV-DO standard provides a fast access mobile station 105 with download speeds of up to 2.4 Mb/s with Rev. 0 and up to 3.1 Mb/s with Rev. A. The mobile station 105 may use the higher speeds with a High Speed Downlink Packet Access (HSDPA) standard of the Third Generation Partnership Project (3GPP). While the 1×EV-DO standard is part of the CDMA2000, the EV-DO Rev. A standard may support low latency services including voice over Internet Protocol (VoIP) and Video Telephony on the same carrier with traditional Internet packet data services.

The wireless communication system 100 may enable in-flight use of the mobile station 105 to communicate with a user on the ground 122. In one embodiment, first and second base stations 115(1,m) on the ground 122 may provide access to a user of the mobile station 105 on-board the aircraft 110 to a digital cellular wireless-service including voice and data services as may be accessible on the ground 122.

To enable a wireless service during flights, for example, a digital cellular wireless service on-board the aircraft 110, the aircraft 110 may comprise an aircraft transceiver 120 that includes a first repeater 125 and a receiver (RX) 130. The aircraft transceiver 120 may provide wireless communications between the first and second base stations 115(1,m) and the mobile device 105. By using the first repeater 125, the aircraft transceiver 120 enables use of the mobile device 105 while the aircraft 110 is airborne.

In particular, the first repeater 125 may translate frequency of a receive (RX) signal 135 on board the aircraft 110. That is, the receiver 130 may receive the receive signal 135 over a first carrier frequency 140a on a forward link 145. The first repeater 125 may translate a frequency of the receive signal 135 to a cellular frequency band 150 from a first frequency band different than the cellular frequency band. For example, the first repeater 125 may translate the frequency from a non-cellular frequency band 155.

For a reverse link 160, the first repeater 125 may likewise translate a frequency of a transmit (TX) signal 165 for transmission on as second carrier frequency 140b on board the aircraft 110 from the cellular band frequency 150 to the non-cellular frequency band 155. In this way, the first repeater 125 may provide a transmit signal on non-cellular band 165a from the mobile station 105 to the first base station 115(1) on the reverse link 160. Conversely, the first repeater 125 may provide a receive signal on non-cellular band 135a to the mobile station 105 in response to the receive signal 135 received on the forward link 145 from the first base station 115(1).

Examples of the wireless communication system 100 includes an Air-To-Ground (ATG) Broadband Data system, within the United States of America (USA), the non-cellular frequency band 155 or the ATG band is located at 849-851 MHz for ground to air and 894-896 MHz for air to ground communications. The ATG band is located adjacent to the cellular band and with a wide spectrum to fit at least one EV-DO carrier (e.g., 2 MHz) based on a CDMA 1×EV-DO Rev. A terrestrial protocol. The CDMA2000 EV-DO backhaul system consists of three elements: the ground stations, the associated core network, and aeronautical electronic unit (AEU) installed on the aircrafts.

To translate the frequency of the transmit signal on non-cellular band 165a to the transmit signal 165 having a frequency in the cellular frequency band 150, the first base station 115(1) may comprise a second repeater 170. The second repeater 170 may further translate the receive signal on cellular band 135a to the receive signal 135 for transmission on the forward link 145 to the aircraft transceiver 120.

Consistent with one embodiment, the first and second base stations 115(1,m) may provide air-to-ground and ground-to-air communications over an air interface 175, for example, when the aircraft 110 is airborne (for the mobile station 105). A radio network controller may coordinate a handover of such communications upon a user leaving an area of responsibility of one base station 115(1), into another base station 115(m). That is, a handover of mobile communications occurs for the mobile station 105 when responsibility of communication switches from a first cell sector served by the first base station 115(1) to a second cell sector served by the second base station 115(m).

Each base station 115 may comprise a directional antenna 180 that may point skyward an antenna beam for the aircraft transceiver 120. The aircraft transceiver 120 may comprise an antenna 180a that may be disposed at a bottom portion 185, such as the belly of the aircraft 110. For example, the antenna 180a may couple to the aircraft 110 at its belly. The antenna 180(1) may comprise a tower at a ground station to communicate with the aircraft 120. The antenna 180a associated with the aircraft transceiver 120 may include an aeronautical antenna that may communicate with the first base station 115(1) in an air-to-ground frequency band, for example, 485, 851 MHz for a ground-to-air link and at 894, 896 MHz for an air-to-ground link.

The base stations 115(1-m) may be sparsely placed on the ground 122 over a desired geographical area. A cell radius of about 150 miles, a radio horizon of an airplane may be based on an altitude of about 10,000 feet. A separation of about 225 miles between the base stations 115(1-m) on the ground 122 may form a contiguous and overlapping coverage for radio frequency (RF) signals. Each base station 115 may comprise a sectorized cellular antenna 180. For example, a 3-sector cellular antenna having a gain of 18 decibles (dB) along with a vertical beam width on the order of 10° may provide a main lobe of the antenna beams to the radio horizon. An aeronautical antenna 180a may be mounted under the belly of the aircraft 110 may provide a radiation pattern pointing vertically down.

Each antenna 180 associated with a different base station 115 on the ground 122 may provide an independent coverage area 190 for the wireless communication system 110 to carry radio frequency (RF) signals between the first and second base stations 115(1,m) located on the ground 122 and the mobile station 105 on board the aircraft 110.

More particularly, the first base station 115(1) may provide a first radio frequency (RF) coverage area 190(1) and the second base station 115(m) may provide a second RF coverage area 190(m) such that the two coverage areas substantially overlap. By overlapping the coverage areas 190 of contiguous base stations, the wireless communication system 100 may provide a handoff, such as a soft handoff between cells. The receiver 130 may determine an indication of a global position, a speed and/or a direction for the mobile station 105 being used during flight at the aircraft 110. Based on the indication of global positioning, the first repeater 125 may enable a soft handoff between at least two cells associated with the first and/or the base stations 115(1,m).

To provide a handoff between base stations 115, the aircraft 110 may communicate with at least one base station that is within a radio horizon of the aircraft 110. For example, the aircraft 110 may communicate with a closest base station 115. The aircraft transceiver 120 may indicate the closest base station 115 based on an on-board database. In other words, the aircraft 110 may maintain a database for the base stations 115(1,m). To enable a handoff between base stations, such as the first and second base stations 115(1,m), the aircraft 110 may maintain at least two antenna beams. For example, a second antenna beam may point to a next base station for soft handoff. Likewise, to provide a handoff between a non-cellular band, such as the air-to-ground frequency band 155 and a cellular band 150, each base station 115 provides the cellular frequency band 150 communication that is capable of supporting air-to-ground communications. Otherwise, a cellular service carrier or provider may use alternate base stations that may be tightly coupled to the network 117 for providing air-to-ground communications.

In one embodiment, a handoff between the two different frequency bands may occur at an altitude range of 200-500 feet for the aircraft 110. In other words, below the altitude of 200-500 feet, the aircraft 110 may communicate with the first base station 115(1) that may be either associated with the network 117 directly or tightly coupled. Above the altitude of 200-500 feet range, the aircraft 110 may communicate with the first and/or second base stations 115(1,m) using the non-cellular or the air-to-ground frequency band 155. In this way, the wireless communication system 100 may switch the frequency bands for a handoff from the cellular frequency band 150 to a terrestrial cellular frequency band such as the non-cellular or air-to-ground frequency band 155 at the altitude range of 200-500 feet to avoid interference. However, a wireless service may remain accessible for the user of the mobile station 105 through different attitudes of the aircraft 110 including at the gate, taxi time, take off, landing and cruise periods.

According to one illustrative embodiment, the first repeater 125 may translate the receive signal 135 on the forward link 145 and the transmit signal 165 for the reverse link 160 from a air-to-ground frequency band, such as the non-cellular frequency band 155 to the cellular frequency band 150 with a desired amplification and filtering. In addition, the first repeater 125 may control the antenna beam from the antenna 180a associated with the first repeater 125. The first repeater 125 may compensate for a frequency shift in response to a Doppler effect to enable soft-handoff between cells. In response to a Doppler effect, e.g., the first repeater 125 may compensate for the frequency shift in the second carrier frequency 140b for the transmit signal 165.

In one embodiment, the first repeater 125 may communicate with the first and second base stations 115(1,m) at the ground 122 based on a conventional terrestrial network protocol. While a terrestrially-based cellular system may provide backhauling for wireless services on board the aircraft 110, the air interface 175 may be based on a Code Division Multiple Access (CDMA) 2000 EV-DO protocol for transmissions over an air-to-ground band at 800 MHz. In this way, a user on board the aircraft 110 may access a wireless data and/or voice service through an access point or a pico-base station having an Internet protocol (IP) based connection to the aircraft transceiver 120 that communicates with the first and/or second base stations 115(1,m) distributed over a geographical area on the ground 110. A backhaul connection may provide a RF communication for the IP traffic to the user of the mobile station 105. Consistent with one embodiment of the present invention, one or more satellite(s) may enable such a backhaul connection.

The mobile station 105 on-board the aircraft 110 may communicate with the first and second base stations 115(1,m), using the first and second repeaters 125, 170 to provide an in-flight service, such as a wideband data service on a network 117. The network 117 may comprise an EV-DO network that enables air-to-ground communications over the air interface 175 between the air transceiver 120 and the first and/or second base stations 115(1,m) responsible for forming an air-to-ground RF link.

The network 117 may further comprise a data center/network operations center which may couple to an enterprise operations center. Using a conventional firewall, the data center may communicate over the Internet that may provide a secure access to a business data network such as a local area network. One example of the base station 115 includes a base transceiver station (BTS) that may couple a base station antenna, such as the antenna 180(1) to a radio network controller (RNC). The radio network controller may couple the base transceiver station to the data center which may include a base station controller (BSC) and a conventional Authentication, Authorization, and Accounting (AAA) and home agent (HA) modules.

The first carrier frequency 140a and the second carrier frequency 140b may be based on the EV-DO standard. For example, an EV-DO carrier of 1.25 MHz may provide terrestrial communications for the mobile device 105. Using the EV-DO carrier, a radio frequency (RF) signal may propagate from the aircraft 110 at high altitude to the ground 122.

The first repeater 125 may compensate for a Doppler shift of the first carrier frequency 140a received at the aircraft receiver 120. Likewise, the second repeater 170 may compensate for a Doppler shift of the second carrier frequency 140b at the base station 115(1). Typically, a Doppler shift occurs at high traveling speed of an airplane that may be cruising at a commercial airline speed of about 500 mph. As a result of such a Doppler shift, a path delay on a first signal path between the first base station 115(1) and the first repeater 125 may rapidly change. Likewise, a path delay over a second signal path 197(2) may rapidly change.

A cell radius of about 150 miles with a radio horizon of an airplane at 10,000 feet altitude for the aircraft 110 may determine separation between the first and second base stations 115(1) to provide a contiguous and overlapping radio frequency (RF) coverage in the air, as illustrated in FIG. 1. For the altitude of a commercial flight to be typically between 10,000 to 35,000 feet above sea-level, the antenna's 180(1-m) may point upwards on the ground 122 for RF propagation on the reverse link 160 between the aircraft 110 and a cell at the ground 122.

In one embodiment, the aircraft transceiver 120a may configure a Wi-Fi network inside the aircraft 110. The Wi-Fi network may comprise a plurality of access points, such as, based on the Institute of Electrical and Electronics Engineers (IEEE) 802.11 standard to provide a user of the mobile station 105, a wireless service at a desired data rate, the cell radius for a cell or a number of sectors per cell may determine support for a particular throughput level that a sector may support or the cell radius that may be supported by the aircraft transceiver 120. For example, for 4 kilobits per second (kbps) per user throughput may indicate a throughput per plane of 120 kbps for supporting ten planes per sector with the cell radius of about 150 miles.

According to one embodiment, the non-cellular or air-to-ground frequency bands for use with ground-to-air and air-to-ground communications may use a frequency adjacent to the cellular frequency range for the forward link 145 and the reverse link 160 transmissions. In one embodiment, transmit and receive frequency of a base station 115 on the ground 122 may be opposite to the cellular frequency.

A frequency offset to the first and second carrier frequencies 140a, 140b may compensate for the Doppler effect as a result of high traveling speed of the aircraft 110. A backhaul link may provide coverage for a wireless service in the wireless communication system 100 over a large geographical area. For example, a satellite based backhaul link may enable long flights, such as intercontinental flights to provide a wireless service to the mobile station 105.

Each base station 115 may provide a single carrier for a plurality of sectors. The base station 115 may convert cellular frequencies to non-cellular or air-to-ground frequencies. The base station 115 may support a boomer cell of 150 mile radius. In one embodiment, the aircraft 110 may use the directional antenna 180a mounted at the belly to communicate with first and second base station 115(1,m). By using the directional antenna 180a, the aircraft 110 may reduce inter-cell interference, while increasing throughput of the wireless communication system 100. That is, the directional antenna 180a may cause the aircraft 110 to communicate with one base station adjacent to a serving base station. However, the directional antenna 180a may cause the aircraft 110 to not communicate with a base station beyond the radio horizon.

To provide a soft handoff, the directional antenna 180a may form two or more independent beams with independent compensation for a carrier offset and a rapidly changing path delay to the base stations 115 in response to the Doppler effect. For example, the first and second repeaters 125 and 170 may compensate the carrier offset within a frequency conversion process. Likewise, compensation for a path delay may be based on the indication for global positioning, such as GPS information in the digital baseband.

The plurality of base stations 115(1-m) may provide the wireless connectivity to at least one mobile station 105 according to any desirable protocol. Examples of a protocol include a Code Division Multiple Access (CDMA, CDMA2000) protocol, wideband-CDMA (WCDMA)/Universal Mobile Telecommunication System (UMTS) protocol, a Global System for Mobile communications (GSM) protocol, and like.

Examples of the mobile station 105 may include a host of wireless communication devices including, but not limited to, cellular telephones, personal digital assistants (PDAs), and global positioning systems (GPS) that employ the wireless communication system 100 to operate in a high-speed wireless data network, such as a digital cellular CDMA network. Other examples of the mobile stations 105 may include smart phones, text messaging devices, and the like.

Each of the base stations 115, sometimes referred to as Node-Bs, may provide connectivity to associated geographical areas within a wireless data network. Persons of ordinary skill in the art should appreciate that portions of such a wireless data network may be suitably implemented in any number of ways to include other components using hardware, software, or a combination thereof. Wireless data networks are known to persons of ordinary skill in the art and so, in the interest of clarity, only those aspects of a wireless data network that are relevant to the present invention will be described herein.

According to one embodiment, using the first and second repeaters 125, 170, the mobile station 105 may communicate with an active base station on the reverse link 160 to the first and second base stations 115(1,m). An active base station is generally referred to as the serving base station or the serving sector. The 3rd Generation Partnership Project (3GPP2) standard defines the role of a serving base station or a serving sector and a serving radio network controller based on 3GPP2 specifications. The first and second base stations 115(1,m) may communicate with the mobile station 105 over the forward link 145.

The forward link 145 and the reverse link 160 may be established on a plurality of channels. The channels, such as traffic and control channels may be associated with separate channel frequency bands. In one embodiment, the wireless communication system 100 may be based on a cellular network, which at least in part, may be based on a Universal Mobile Telecommunications System (UMTS) standard. The cellular network may be related to any one of the 2G, 3G, or 4G standards that employ any one of the protocols including the UMTS, CDMA2000, or the like, however, use of a particular standard or a specific protocol is a matter of design choice and not necessarily material to the present invention.

In this way, the mobile station 105 may transmit and receive packet data associated with a digital wireless service to and from a cell sector associated with one or more of the base stations 115 (1-m). In one embodiment, transmission of the packet data and other data including messages, packets, datagram, frames, and the like between the mobile station 105 and the base stations 115 (1-m). The term “packet data” may include information or media content that has been arranged in a desired manner. The packet data may be transmitted as frames including, but not limited to, a Radio Link Protocol (RLP) frame, Signaling Link Protocol (SLP) frame or any other desired format. Examples of the packet data may include a payload data packet representative of voice, video, signaling, media content, or any other type of information based on a specific application.

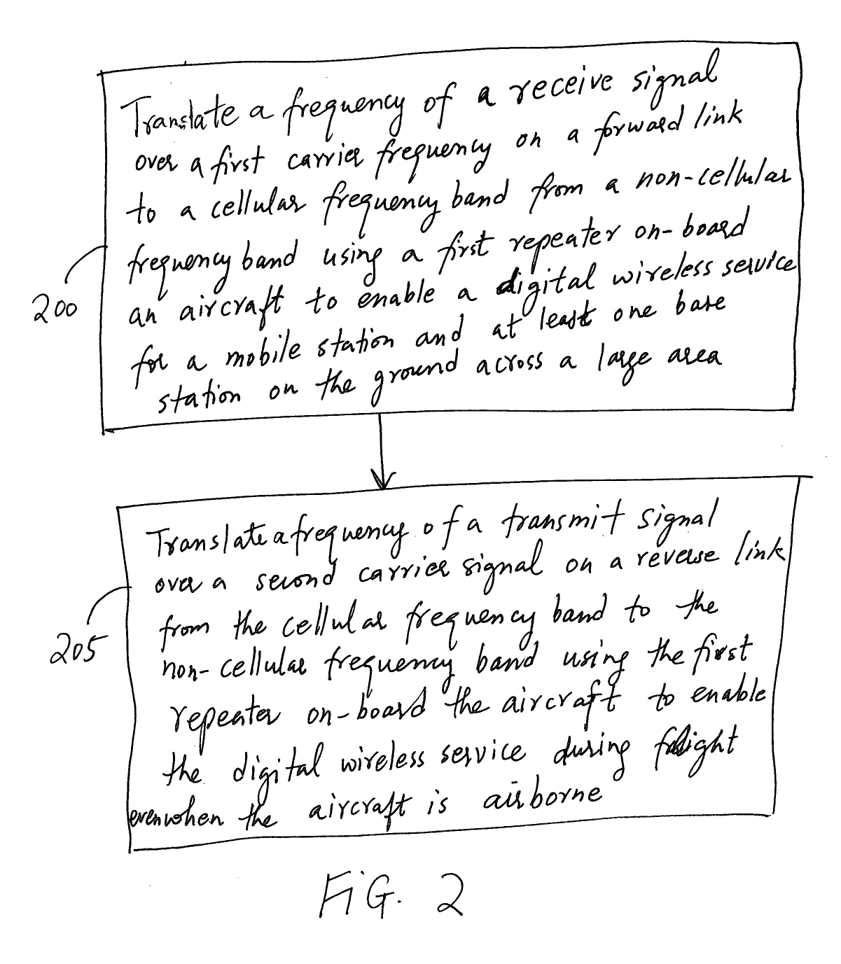

Referring to FIG. 2, a stylized representation for implementing a method of enabling a digital wireless service is schematically depicted for the mobile station 105 on board the aircraft 110 and at least one base station of the first and second base stations 115(1,m) at the ground 122, according to one embodiment of the present invention. At block 200, the first repeater 125 may translate a frequency of the receive signal 135 over the first carrier frequency 140a on the forward link 145 to the cellular frequency band 150 from the non-cellular frequency band 155.

The first repeater 125 may translate a frequency of the transmit signal 165 over the second carrier frequency 140b on the reverse link 160 from the cellular frequency band 150 to the non-cellular frequency band 155, as indicated in block 205. By translating frequencies of the two different frequency bands on board the aircraft 110, the first repeater 125 may enable the mobile station 105 to communicate with the base stations 115 during flight.

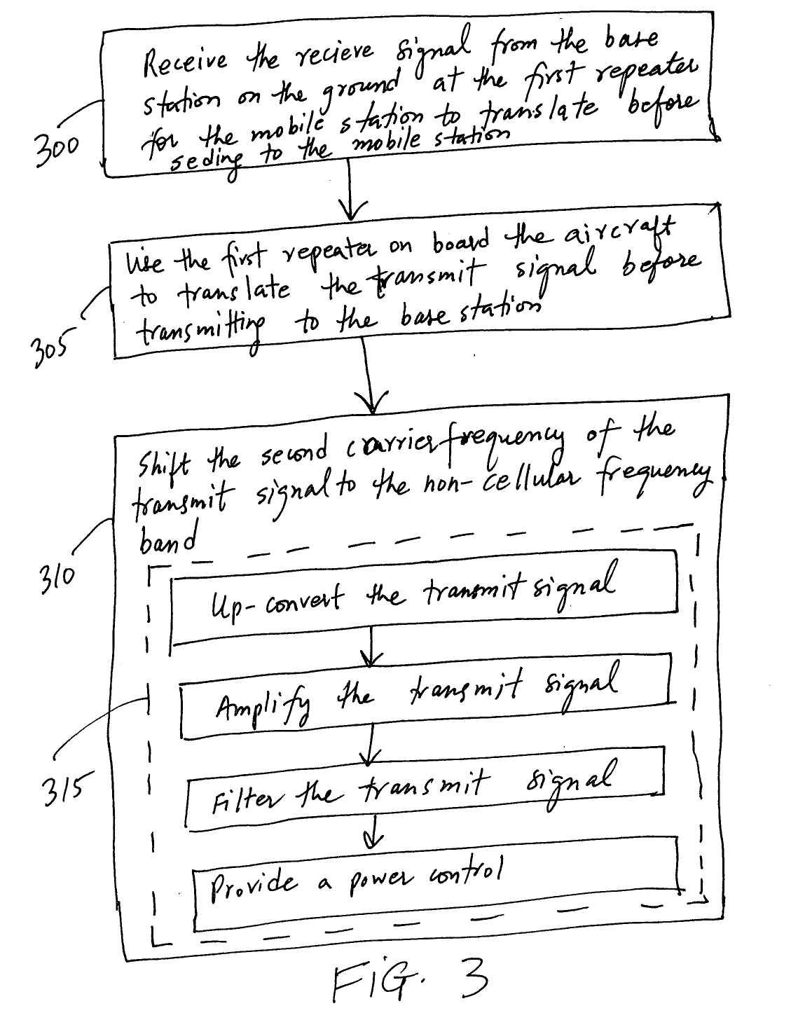

Referring to FIG. 3, a stylized representation for implementing a method of translating the frequency of the transmit signal 165, e.g., when the aircraft 110 is airborne, is schematically illustrated in accordance with one embodiment of the present invention. At block 300, the receiver 130 may receive at the first repeater 125 the receive signal 135 from the first base station 115(1) for the mobile station 105. On board the aircraft 110, the first repeater 125 may translate the frequency of the receive signal 135 while the aircraft 110 is airborne before sending a receive signal on the cellular frequency band 150 to the mobile station 105. Likewise, before transmitting the transmit signal on non-cellular band 165a on the reverse link 160, the first repeater 125 may translate the transmit signal 165 while the aircraft 110 is airborne, as shown in block 305.

To translate the frequency of the transmit signal 165, at block 310, the first repeater 125 may shift the second carrier frequency 140b to the non-cellular frequency band 155. This carrier frequency shift may reduce interference of the transmit signal on non-carrier band 165a with one or more wireless communication systems located on the ground 122.

At block 315, to shift the second carrier frequency 140b, the first repeater 125 may up-convert the transmit signal 165. That is, the frequency of the transmit signal 165 may be up-converted to the non-cellular frequency band 155 that is adjacent to a frequency of a satellite radio band. The first repeater 125 may amplify and filter the transmit signal 165 to meet a given emission threshold. In addition, the first repeater 125 may provide a power control to obtain a desired system capacity or transmission from a plurality of directional antennas at the antenna 180a.

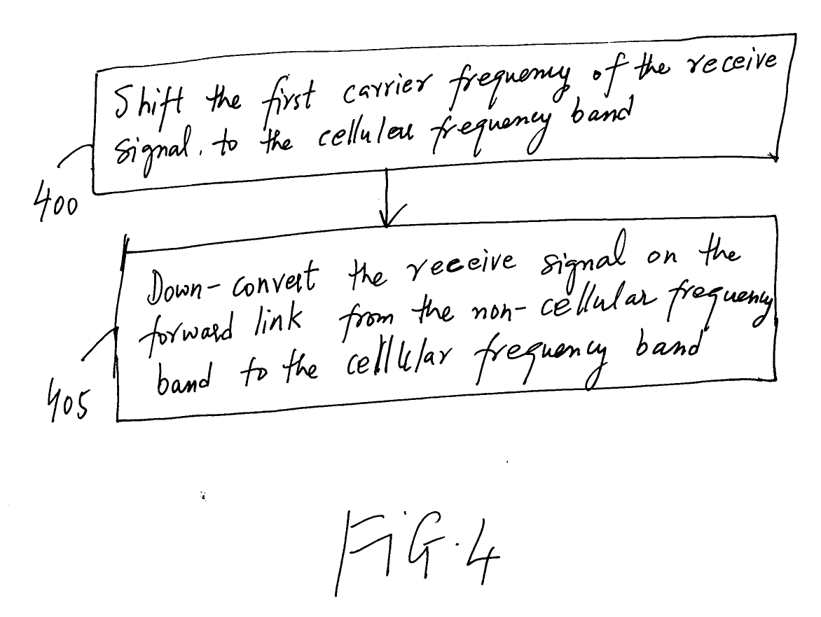

Referring to FIG. 4, a stylized representation for implementing a method of receiving the receive signal 135 at the first repeater 125 for the mobile station 105 is schematically illustrated in accordance with one embodiment of the present invention. At block 400, the first repeater 125 may shift the first carrier frequency 140a to the carrier frequency band 150. To shift the carrier frequency, at block 405, the first repeater 125 may down-convert the receive signal 135 on the forward link 145 from the non-cellular frequency band 155 to the cellular frequency band 150.

The second repeater 170 may amplify and filter the transmit signal on non-cellular and 165a to provide a desired wireless communication. The second repeater 170 may down-convert the receive signal on the reverse link 160 from the non-cellular frequency band 155 to the cellular frequency band 150.

The first repeater 125 may determine a frequency offset in the first carrier frequency 140a of the received signal 135 to obviate the Doppler effect. To correct for the frequency offset, the first repeater 125 may shift the first carrier frequency 140a during frequency translation. By determining the distance to the first base station 115(1), the first repeater 125 may compensate for a change in a path delay on a first signal path 197(1). The global position of the first repeater 125 may be determined by a Global Positioning System (GPS). The position of the base stations 115(1-m) can be pre-loaded in the repeater 125 or communicated to the repeater over the wireless connection. For example, the first repeater 125 may inject a delay on the first signal path 197(1) from the first base station 115(1) to the aircraft transceiver 120.

To inject a desired delay on the first signal path 197(1), the first repeater 125 may determine a distance (D) 199 between the aircraft 110 and the first base station 115(1) on the ground 122. The first repeater 125 may compare the distance 199 to a threshold. If the distance 199 is ascertained to be smaller than the threshold, the first repeater 125 injects the desired delay to the first signal path 197(1).

To reduce size of a search window, the first repeater 125 may compensate for a path difference between the first signal path 197(1) and a second signal path 197(2). That is, if the distance 199 is determined to be smaller than the threshold, another delay is injected to the first signal path 197(1). By injecting the delay, the first repeater 125 may compensate for the path difference.

In one embodiment, the first repeater 125 may determine whether a Doppler shift between the first base station 115(1) and the second base station 115(m) exceeds a threshold during a handoff. If so, the first repeater 125 may independently correct a signal path 197 for the Doppler shift. In another embodiment, the aircraft transceiver 120 may include a second repeater in conjunction with the first repeater 125 such that the first repeater 125 provides a first directional antenna pointing in a forward direction and the second repeater provides a second directional antenna pointing in a backward direction.

To obviate a pilot pollution experienced by the first repeater 125, the first repeater 125 may detect a pilot signal associated with a number of base stations 115 to the aircraft 110 for a wireless communication. By detecting the pilot signals, the first repeater 125 may determine whether there exist comparable signal strengths from multiple pilot signals. If so, the first repeater 125 may reconfigure sectoring for the first directional antenna that may be associated with the first repeater 125. Likewise, the sectoring, i.e., the number of sectors for the second directional antenna that may be associated with the second repeater may be reconfigured. In this case, the aircraft transceiver 120 may dynamically change its antenna sectorization.

Consistent with one embodiment, the first repeater 125 may measure a signal strength of the receive signal 135 on the forward link 145. The first repeater 125 may further determine a transmit power of the mobile station 105 that may be active on the reverse link 160 while it is under a power control. Based on the measured signal strength and the determined transmit power, the aircraft transceiver 120 may control a gain of the first repeater 125.

To cause the mobile station 105 to interface, i.e., communicate, with both the first and second base stations 115(1,m) during the handoff, the first repeater 125 may combine radio frequency (RF) signals for the antenna beams pointed to the base stations 115. In particular, a first radio frequency signal of a first antenna beam pointing to the first base station 115(1) may be combined with a first Doppler correction. Likewise, a second radio frequency signal of a second antenna beam pointing to the second base station 115(m) may be combined with a second Doppler correction independent of the first Doppler correction. The first repeater 125 may adjust the relative gain between the first and second antenna beams to control duration of a time period for which the mobile station 105 may stay in the handoff.

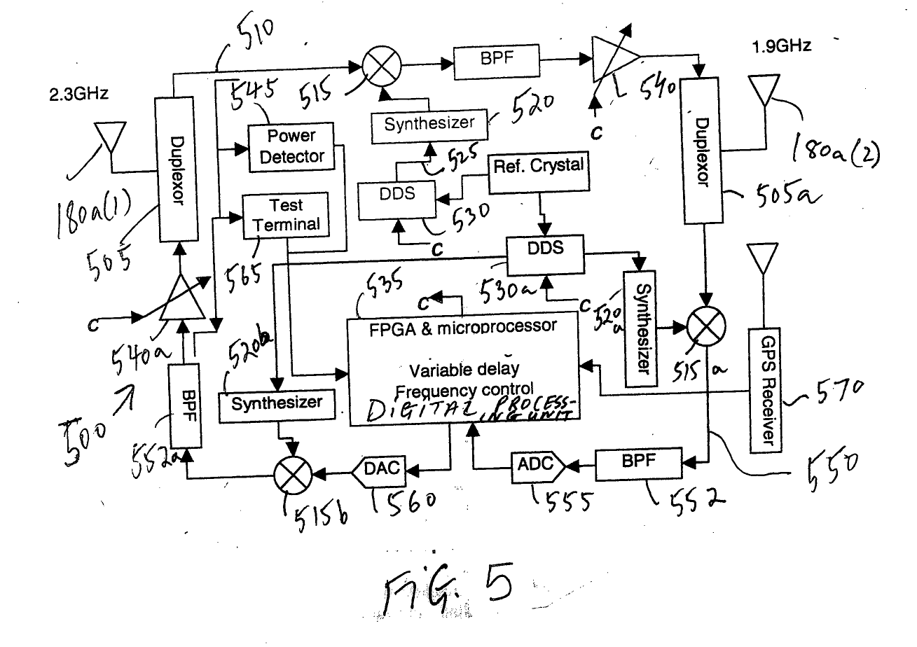

Turning now to FIG. 5, schematically depicts a circuit 500 for the first repeater 125 shown in FIG. 1 according to one embodiment of the present invention. The circuit 500 for the first repeater 125 may comprise a first antenna 180a(1) to form an air to ground link and operate at 2.3 GHz frequency. A duplexer 505 coupled to the first antenna 180a(1) may separate a signal into the forward and reverse links 145, 160, respectively. The circuit 500 includes a forward-link signal path 510 to convert a forward link signal to 1.9 GHz band through a mixer 515. The circuit 500 further comprises a local oscillator for the mixer 515 at a synthesizer 520 having an output 525 coupled to a first Direct Digital Synthesizer (DDS) 530, which in turn, is controlled by a signal “C” from a digital processing unit 535. An example of the first DDS 530 is a digitally controlled sine wave generator.

The first DDS 530 may change the output frequency at the output 525 to compensate for a frequency offset. The circuit 500 may further comprise a second antenna 180a(2) to radiate, within the aircraft 110, the converted forward-link signal that is amplified by a first variable gain amplifier 540. The digital processing unit 535 may control the gain of the amplification of the converted forward-link signal. To measure the power from a base transceiver station (BTS), i.e., the base station 115(1), the circuit 500 may comprise a power detector 545 to control the gain of the first repeater 125 for both the forward and reverse links 145, 160.

The circuit 500 may comprise a reverse link signal path 550 to receive a signal from the mobile station 105 within the aircraft 110. The circuit 500 may include a second mixer 515a to down convert the received signal to either a baseband or a low intermediate frequency (IF), a first band pass filter (BPF) 552 to filter and an analog to digital converter (ADC) 555 to sample the down-converted and filtered, received signal into digital samples. The analog to digital converter (ADC) 555 may pass the digital samples onto the digital processing unit 535. After further processing, the digital processing unit 535 may pass the digital samples to a digital to analog converter (DAC) 560 to convert back to analog domain. A third mixer 515b may up convert the analog IF or baseband signal to the 2.3 GHz band. A second band pass filter (BPF) 552a may filter, a second variable gain amplifier 540a may amplify the signal before the first antenna 180a(1) radiates the signal to the base station 115(1) on the ground 122.

A second DDS 530a may separately reference the frequency conversions in the reverse link signal path 550 than the frequency conversions in the forward link signal path 510. Again, by controlling the second DDS 530a output, the circuit 500 may compensate the Doppler frequency offset. Moreover, the digital processing unit 535 may control the overall gain of the reverse link signal path 550.

The digital processing unit 535 may provide control signals “C” to operate the first repeater 125. Examples of the digital processing unit 535 include a Field Programmable Gate Array (FPGA) and a microprocessor or a FPGA with an embedded microprocessor. The digital processing unit 535 may monitor the state of the first repeater 125 by gathering information from the power detector 545, a test terminal 560 and a global positioning system (GPS) receiver 570. The power detector 545 may measure the signal strength of the receive signal 135 from the base station 115(1) at the ground 122. The test terminal 565 may enable a closed-loop power control on the first repeater 125 as well as send and receive information to and from the base station 115(1) at the ground 122 to controllably operate the circuit 500. The GPS receiver 570 may provide information on the current location, altitude, traveling speed and direction of the aircraft 110.

The digital processing unit 535 may use all the information set forth above to identify a serving bases station(s), calculate the Doppler frequency offset of and distance to the serving base station(s), and calculate a desired value for applying the gains to the signal paths 510 and 550. The digital processing unit 535 may control the first and second DDSs 530, 530a to compensate for Doppler frequency offset.

The digital processing unit 535 may adjust the gains of the signal paths 520, 550 by tuning the first and second variable gain amplifiers 540, 540a, and add desired delays into the signal paths 510, 550 to compensate for the delay change and reduce search window used at the base stations 115 at the ground 122. The digital processing unit 535 may use a variable digital delay based on a tapped delay line. For example, a tap position on the tapped delay line may determine the delay. However, the circuit 500 may provide frequency offset compensation and delay compensation independently of each other

Although the first DDS 530 is shown to provide frequency offset compensation, in another embodiment, a digital modulator in the FPGA of the digital processing unit 535 may compensate for the frequency offset. Likewise, delay compensation may be added to the forward link signal path 510 as well. In this way, the circuit 500 for the first repeater 125 may compensate for delay on both the forward link signal path 510 and the reverse link signal path 550, according to one embodiment of the present invention.

According to one embodiment, to enable a digital wireless service for the mobile station 105, the wireless communication system 100 may include one or more pico-cells on the aircraft 110. For example, a plurality of pico-cells deployed on board the aircraft 110 may enable the mobile stations 105 or handsets provide by different service providers with different air-interface implementations.

The wireless communication system 100 may provide backhaul for the pico-cells. For example, the test terminal 565 in the first repeater 125 may aggregate the traffic from the pico-cells and backhaul it to the base stations 115 at the ground 122 through a high-speed downlink packet access (HSPDA) and enhanced dedicated channel (EDCH) channel. Since the first repeater 125 may provide the Doppler shift compensation, the test terminal 565 may be a conventional data Personal Computer Memory Card International Association (PCMCIA) card, for example.

The wireless communication system 100 may leverage existing large volume standard cellular wireless infrastructure equipment and user equipment, many communication needs of air travelers may be met at a reasonable cost. In addition, may continue to use their own personal communication device(s) with features that users are accustomed to and are familiar with and constantly rely on to communicate wirelessly.

In one embodiment, the wireless communication system 100 may wirelessly communicate mobile data at a speed and coverage desired by individual users or enterprises. According to one embodiment, the high-speed wireless data network may comprise one or more data networks, such as Internet Protocol (IP) network comprising the Internet and a public telephone system (PSTN). The 3rd generation (3G) mobile communication system, namely Universal Mobile Telecommunication System (UMTS) supports multimedia services according to 3rd Generation Partnership Project (3GPP) specifications. The UMTS also referred as Wideband Code Division Multiple Access (WCDMA) includes Core Networks (CN) that are packet switched networks, e.g., IP-based networks. Because of the merging of Internet and mobile applications, the UMTS users can access both telecommunications and Internet resources. To provide an end-to-end service to users, a UMTS network may deploy a UMTS bearer service layered architecture specified by Third Generation Project Partnership (3GPP) standard. The provision of the end-to-end service is conveyed over several networks and realized by the interaction of the protocol layers.

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

The present invention set forth above is described with reference to the attached figures. Various structures, systems and devices are schematically depicted in the drawings for purposes of explanation only and so as to not obscure the present invention with details that are well known to those skilled in the art. Nevertheless, the attached drawings are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

While the invention has been illustrated herein as being useful in a telecommunications network environment, it also has application in other connected environments. For example, two or more of the devices described above may be coupled together via device-to-device connections, such as by hard cabling, radio frequency signals (e.g., 802.11(a), 802.11(b), 802.11(g), Bluetooth, or the like), infrared coupling, telephone lines and modems, or the like. The present invention may have application in any environment where two or more users are interconnected and capable of communicating with one another.

Those skilled in the art will appreciate that the various system layers, routines, or modules illustrated in the various embodiments herein may be executable control units. The control units may include a microprocessor, a microcontroller, a digital signal processor, a processor card (including one or more microprocessors or controllers), or other control or computing devices as well as executable instructions contained within one or more storage devices. The storage devices may include one or more machine-readable storage media for storing data and instructions. The storage media may include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy, removable disks; other magnetic media including tape; and optical media such as compact disks (CDs) or digital video disks (DVDs). Instructions that make up the various software layers, routines, or modules in the various systems may be stored in respective storage devices. The instructions, when executed by a respective control unit, causes the corresponding system to perform programmed acts.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed:

1. A method for enabling a digital wireless service across a first and a second wireless communications environment, the method comprising:
in the first wireless communications environment, translating a receive signal carried on a forward link and having a first carrier frequency from a first frequency band to a second frequency band different from the first frequency band; and
in the first wireless communications environment, translating a transmit signal carried on a reverse link and having a second carrier frequency from said second frequency band to said first frequency band.

2. A method, as set forth in claim 1, wherein translating said receive signal further comprises:
receiving said receive signal from a base station for a mobile station at a first repeater on board an aircraft to translate the frequency of said receive signal when the aircraft is airborne before sending said receive signal to said mobile station.

3. A method, as set forth in claim 2, wherein translating said transmit signal further comprises:
using said first repeater to translate the frequency of said transmit signal when the aircraft is airborne before transmitting said transmit signal to said base station.

4. A method, as set forth in claim 1, further comprising:
shifting said second carrier frequency of said transmit signal on said reverse link to said first frequency band that does not interfere with one or more wireless communication systems on the ground.

5. A method, as set forth in claim 4, further comprising:
up-converting said transmit signal on said reverse link from a cellular frequency band to said first frequency band that is adjacent to a frequency of a satellite radio band;
amplifying said transmit signal;
filtering said transmit signal to meet a given emission threshold; and
providing a power control to obtain at least one of a desired system capacity and transmission from a plurality of directional antennas.

6. A method, as set forth in claim 4, further comprising:
coupling a receiver to said first repeater for determining an indication of at least one of a global position, a speed and a direction; and
in response to a Doppler effect, compensating for a frequency shift in said second carrier frequency based on said indication to enable a soft handoff between a first cell associated with a first base station and a second cell associated with a second base station.

7. A method, as set forth in claim 2, wherein receiving said receive signal from said base station for said mobile station at said first repeater further comprises:
shifting said first carrier frequency of said receive signal to a cellular frequency band.

8. A method, as set forth in claim 7, wherein shifting said first carrier frequency of said receive signal further comprises:
down-converting said receive signal on said forward link from a non-cellular frequency band to said cellular frequency band.

9. A method, as set forth in claim 1, further comprising:
in support of the digital wireless service, operating at least two base stations disposed on the ground, each base station having an antenna that points skyward to create a substantially contiguous and overlapping coverage for an air interface to carry radio frequency signals.

10. A method, as set forth in claim 9, further comprising:
operating a second repeater at each of said at least two base stations to up-convert said transmit signal on said forward link from a cellular frequency band to a non-cellular frequency band.

11. A method, as set forth in claim 10, wherein operating a second repeater further comprises:
amplifying said transmit signal;
filtering said transmit signals; and
down-converting said receive signal on said reverse link from said non-cellular frequency band to said cellular frequency band.

12. A method, as set forth in claim 1, further comprising:
measuring a signal strength of said receive signal on said forward link;
determining a transmit power of a terminal active on said reverse link and is under a power control; and
controlling a gain of said first repeater based on the measured signal strength and the determined transmit power.

13. A method, as set forth in claim 1, further comprising:
in response to a Doppler effect, determining a frequency offset in said first carrier frequency of said receive signal; and
shifting said first carrier frequency during frequency translation to correct for said frequency offset.

14. A method, as set forth in claim 1, further comprising:
in response to a Doppler effect, measuring from a global positioning signal the total path delay;
compensating for a change in a path delay from a base station based on said total path delay.

15. A method, as set forth in claim 1, further comprising:
determining a distance between an aircraft and a base station on the ground;
comparing the distance to a threshold; and
if the distance is smaller than said threshold, injecting a delay to a signal path from said base station.

16. A method, as set forth in claim 15, further comprising:
in response to said delay, compensating for a path difference for reducing size of a search window.

17. A method, as set forth in claim 1, further comprising:
determining whether a Doppler shift between a first base station and a second base station exceeds a threshold during a handoff; and
if so, independently correcting each signal path from said first base station and said second base station for said Doppler shift.

18. A method, as set forth in claim 17, further comprising:
using another repeater in conjunction with said first repeater, said first repeater having a first directional antenna pointing in a forward direction and said another repeater having a second directional antenna pointing in a backward direction.

19. A method, as set forth in claim 18, further comprising:
detecting a pilot signal associated with a number of base stations to an aircraft for a wireless communication to determine whether said pilot signal exceeds a threshold; and
if so, sectoring further said first directional antenna associated with said first repeater and said second directional antenna associated with said another repeater.

20. A method, as set forth in claim 17, further comprising:
combining a first radio frequency signal of a first antenna beam pointing to said first base station with a first Doppler correction and a second radio frequency signal of a second antenna beam pointing to said second base station with a second Doppler correction independent of said first Doppler correction such that a mobile station interfaces with both said first and second base stations during the handoff.

21. A method, as set forth in claim 20, further comprising:
adjusting a relative gain between the signals received from said first and second antenna beams to control a duration of a time period for which said mobile station stays in the handoff.

22. A method, as set forth in claim 1, wherein said first wireless communications environment at an aircraft enables said digital wireless service across a second wireless communications environment.

23. A method, as set forth in claim 1, wherein said first wireless communications environment is mobile relative to said second wireless communications environment.

24. A method, as set forth in claim 1, wherein said first wireless communications environment includes a repeater disposed at an aircraft to enable said digital wireless service for a mobile station in a second wireless communications environment that includes a base station on the ground.

25. A method for enabling a digital wireless service on board an aircraft for a mobile station and at least one base station on the ground, the method comprising:
translating, on board the aircraft, a frequency of a receive signal over a first carrier frequency on a forward link to a cellular frequency band from a non-cellular frequency band; and
translating, on board the aircraft, a frequency of a transmit signal over a second carrier frequency on a reverse link from said cellular frequency band to said non-cellular frequency band.
